(19) United States
(12) Patent Application Publication
(10) Pub. No.: US 2023/0282437 A1
(43) Pub. Date: Sep. 7, 2023

(54) TARGET ASSEMBLY, X-RAY APPARATUS, STRUCTURE MEASUREMENT APPARATUS, STRUCTURE MEASUREMENT METHOD, AND METHOD OF MODIFYING A TARGET ASSEMBLY

(71) Applicant: NIKON METROLOGY NV, Leuven (BE)

(72) Inventor: Ian George HAIG, UXBRIDGE (GB)

(21) Appl. No.: 18/017,301

(22) PCT Filed: Jul. 23, 2021
(86) PCT No.: PCT/EP2021/070687

§ 371 Date: Jan. 20, 2023

(30) Foreign Application Priority Data
Jul. 23, 2020 (GB) 2011389.0

(51) Int. Cl. H01J 35/18

(52) U.S. Cl. CPC H01J 35/18; H01J 2235/168; H01J 2235/18

(57) ABSTRACT

Provided is a target assembly for an x-ray apparatus comprising a target housing and an entrance path formed in an entrance part of the target housing for accepting an incident electron beam, as well as a target member for generating x-rays under electron beam illumination through the entrance path and an exit path formed in an exit part of the target housing for allowing generated x-rays to exit the target assembly, the exit path being covered by an x-ray transmissive window. In the assembly, the exit path comprises an exit bore formed in the exit part which is configured to limit the generation of x-rays by impact of scattered electrons, which have been reflected from the target member, onto an inside of the bore. Also provided is a target assembly, an x-ray apparatus, a structure measurement apparatus, a structure measurement method, and a method of modifying a target assembly.

### FIELD OF INVENTION

The present invention relates to a target assembly for an X-ray apparatus, and particularly a target assembly for an X-ray apparatus which is a reflection target assembly.

The present invention also relates to an X-ray apparatus comprising of target assembly, a structure measurement apparatus comprising the X-ray apparatus, a structure measurement method using the X-ray apparatus and a method of modifying a target assembly for the X-ray apparatus.

### BACKGROUND

For generation of X-rays, and in particular for the generation of X-rays for the use in imaging and structure-measurement techniques, it is conventional to apply an electron beam to an X-ray generating target in order to produce a desired X-ray beam.

However, depending on the construction of a housing for housing the target, undesired secondary images can be observed, which tend to reduce the image sharpness and fidelity. Moreover, the presence of such secondary images can provide poor results when reconstruction techniques such as CT (computerised tomography) are used to reconstruct volumetric data (such as a volumetric image) from the acquired images.

Accordingly, there is a need for a target assembly for an X-ray apparatus which improves image sharpness and fidelity and can provide reliable volumetric reconstructions, in particular by suppressing incidents of secondary images.

### SUMMARY OF THE INVENTION

According to a first aspect of the present invention, there is provided a target assembly for an x-ray apparatus.

The target assembly comprises a target housing.

The target assembly comprises an entrance path. The entrance path is formed in an entrance part of the target housing. The entrance path accepts an incident electron beam.

The target assembly comprises a target member. The target member is for generating x-rays under electron beam illumination. The electron beam illumination is through the entrance path.

The target assembly comprises an exit path. The exit path is formed in an exit part of the target housing. The exit path is for allowing generated x-rays to exit the target assembly. The exit path is covered by an x-ray transmissive window. The exit path comprises an exit bore. The exit bore is formed in the exit part. The exit bore is configured to limit the generation of x-rays by impact of electrons, which have been reflected from the target member, onto an inside of the bore.

In some embodiments, the exit bore is non-cylindrical.

In some embodiments, the exit bore increases in cross-section in a direction from an x-ray entrance side of the bore.

In some embodiments, wherein the exit bore is conical.

In some embodiments, the exit bore has a cone angle matching a cone angle defined between an x-ray incidence point on the target and an exit aperture of the exit bore.

In some embodiments, the exit part has a plug providing the exit bore.

In some embodiments, the exit bore is provided with a liner predominantly composed of a material having lower atomic number than the atomic number of the predominant material of a surface of the exit part inward of the liner. In some embodiments, the liner is composed of the material having lower atomic number than the atomic number of the predominant material of a surface of the exit part inward of the liner. In some embodiments, the atomic number is lower than 16. In some embodiments, the liner extends substantially around a cross-section of the bore.

In some embodiments, the exit bore is provided with a liner of aluminium, beryllium or carbon.

In some embodiments, the liner has a wall thickness which is greater than the penetration depth of electrons with which the target is designed to operate.

In some embodiments, the liner has a wall thickness which is greater than 10 micron. In some embodiments, the liner has a wall thickness which is greater than 15 micron. In some embodiments, the liner has a wall thickness which is greater than 25 micron. In some embodiments, the liner has a wall thickness which is greater than 50 micron. In some embodiments, the liner has a wall thickness which is greater than 100 micron.

In some embodiments, the liner has a wall thickness which is less than 2 mm. In some embodiments, the liner has a wall thickness which is less than 1 mm. In some embodiments, the liner has a wall thickness which is less than 500 micron. In some embodiments, the liner has a wall thickness which is less than 250 micron.

In some embodiments, the liner has a projection portion which extends inward of the exit bore. In some embodiments, the liner is interposed between the entrance bore and the target member. In some embodiments, the projection portion has an aperture for admitting the electron beam to the target.

In some embodiments, the projection portion is formed to conform to a surface of the target member, optionally to be spaced apart from a surface of the target member by less than 2 mm, optionally less than 1 mm, optionally less than 500 micron.

In some embodiments, the entrance path is along an entrance bore of the entrance part.

In some embodiments, the entrance path is along a centreline of the entrance bore.

In some embodiments, the entrance bore has a circular cross-section.

In some embodiments, the aperture of the projection portion has a circular cross-section.

In some embodiments, the target member has a rod-shaped target portion. In some embodiments, the rod-shaped target portion arranged to be in the path of the incident electron beam.

In some embodiments, the target housing is radiopaque.

In some embodiments, a body of the target assembly is made of tungsten-copper. In some embodiments, substantially all of the target assembly is made of tungsten-copper.

In some embodiments, the window is made of beryllium, aluminium, graphite or diamond.

According to a second aspect of the present invention, there is provided an x-ray apparatus. The x-ray apparatus comprises the target assembly. The x-ray apparatus comprises an electron beam generator. The electron beam generator is arranged to generate an electron beam. The electron beam is incident on the target member.

In some embodiments, the x-ray apparatus further comprises an electron lens. The electron lens is configured to focus the electron beam to a focal spot. The focal spot is on the target member.

According to a third aspect of the present invention, there is provided a structure measurement apparatus. The structure measurement apparatus comprises the x-ray apparatus. The structure measurement apparatus comprises an x-ray detector. The x-ray detector is arranged for measuring the structure of an object. The object is interposed between the x-ray apparatus and the x-ray detector.

According to a fourth aspect of the present invention, there is provided a structure measurement method. The structure measurement method comprises using the x-ray apparatus and an x-ray detector to measure the structure of an object. The object is interposed between the x-ray apparatus and the x-ray detector.

According to a fifth aspect of the present invention, there is provided a method of modifying a target assembly for an x-ray apparatus. The target assembly comprises a target housing. The target assembly comprises an entrance path. The entrance path is formed in an entrance part of the target housing. The entrance path is for accepting an incident electron beam. The target assembly comprises a target member for generating x-rays under electron beam illumination. The electron beam illumination is through the entrance path. The target assembly comprises an exit path. The exit path is formed in an exit part of the target housing. The exit path is for allowing generated x-rays to exit the target assembly. The exit path is covered by an x-ray transmissive window. The exit path comprises an exit bore. The exit bore is formed in the exit part. The modification comprises limiting the generation of x-rays by incidence of scattered electrons, which have been reflected from the target member, onto an inside of the bore.

In one implementation, the modification comprises modifying the exit bore to be non-cylindrical.

In one implementation, the modification comprises modifying the exit bore to increase in cross-section in a direction from an x-ray entrance side of the bore.

In one implementation, the modification comprises modifying the exit bore to be conical.

In one implementation, the modification comprises modifying the exit bore to have a cone angle matching a cone angle defined between an x-ray incidence point on the target and an exit aperture of the exit bore.

In one implementation, the modification comprises providing a plug to the exit bore.

In one implementation, the modification comprises providing the exit bore with a liner predominantly composed of a material having lower atomic number than the atomic number of the predominant material of a surface of the exit part inward of the liner. In one implementation, the modification comprises providing the exit bore with a liner composed of a material having lower atomic number than the atomic number of the predominant material of a surface of the exit part inward of the liner. In one implementation, the atomic number is lower than 16. In one implementation, the liner extends substantially around a cross-section of the bore.

In one implementation, the modification comprises providing the exit bore with a liner of aluminium, beryllium or carbon.

In one implementation, the liner has a wall thickness which is greater than the penetration depth of electrons with which the target is designed to operate.

In one implementation, the liner has a wall thickness which is greater than 10 micron. In one implementation, the liner has a wall thickness which is greater than 15 micron. In one implementation, the liner has a wall thickness which is greater than 25 micron. In one implementation, the liner has a wall thickness which is greater than 50 micron. In one implementation, the liner has a wall thickness which is greater than 100 micron.

In one implementation, the liner has a wall thickness which is less than 2 mm. In one implementation, the liner has a wall thickness less than 1 mm. In one implementation, the liner has a wall thickness less than 500 micron. In one implementation, the liner has a wall thickness less than 250 micron.

In one implementation, the liner has a projection portion which extends inward of the exit bore. In one implementation, the projection portion is interposed between the entrance bore and the target member. In one implementation, the projection portion has an aperture. In one implementation, the aperture is for admitting the electron beam to the target member.

In one implementation, the projection portion is formed to conform to a surface of the target member. In one implementation, the projection portion is formed to be spaced apart from a surface of the target member by less than 2 mm. In one implementation, the projection portion is formed to be spaced apart from a surface of the target member by less than 1 mm. In one implementation, the projection portion is formed to be spaced apart from a surface of the target member by less than 500 micron.

In one implementation, the entrance path is along an entrance bore of the entrance part.

In one implementation, the entrance path is along a centreline of the entrance bore.

In one implementation, the entrance bore has a circular cross-section.

In one implementation, the aperture of the projection portion has a circular cross-section.

In one implementation, the target member has a rod-shaped target portion. In one implementation, the rod-shaped target portion is arranged to be in the path of the incident electron beam.

In one implementation, the target housing is radiopaque.

In one implementation, the target assembly is made of tungsten-copper.

In one implementation, the window is made of beryllium, aluminium, graphite or diamond.

In one implementation, the method further comprises applying an incident electron beam to the target member and observing reduced x-ray generation from the incidence of electrons, which have been reflected from the target member, onto an inside of the bore.

In one implementation, the method further comprises applying an incident electron beam to the target member and observing a reduced intensity of ghost images of a test object. In one implementation, the ghost images are arranged on a circular locus surrounding a true image of the test object on an imaging plane. In one implementation, the test object is arranged between the target member and the imaging plane.

In one implementation, the method further comprises adjusting the configuration of the exit bore to observe the reduced intensity of ghost images of the test object.

According to a sixth aspect of the present invention, there is provided a method of modifying an x-ray apparatus comprising the target assembly and an electron beam generator arranged to generate an electron beam incident on the target member. The method comprises modifying the target assembly in accordance with the method of modifying a target assembly for an x-ray apparatus.

In one implementation, the x-ray apparatus further comprises an electron lens configured to focus the electron beam to a focal spot on the target member.

### BRIEF DESCRIPTION OF THE DRAWINGS

To better understand the present invention, and to show how the same may be carried into effect, reference will be made, by way of example only, to the accompanying drawings, in which:

FIG. 1 is a schematic view of an X-ray apparatus in which the present invention can be implemented;

FIG. 2 is a cross-sectional view of an X-ray target assembly which may exhibit problems which the present invention is able to address;

FIG. 3 is a cross-sectional view of a target assembly for an X-ray apparatus according to a first embodiment of the present invention;

FIG. 4 is a cross-section of a target assembly for an X-ray apparatus according to a second embodiment of the present invention;

FIG. 5 is a view of a liner usable in connection with an embodiment of the present invention;

FIG. 6 is a cross-sectional view of the liner of FIG. 5;

FIG. 7 is a sequence of images showing an X-ray image of a radiopaque ball exhibiting a ghost image produced using a conventional target assembly, together with an X-ray image produced using a target assembly as shown in FIG. 3 and an image of a radiopaque ball obtained using the target assembly of FIG. 4.

### DETAILED DESCRIPTION

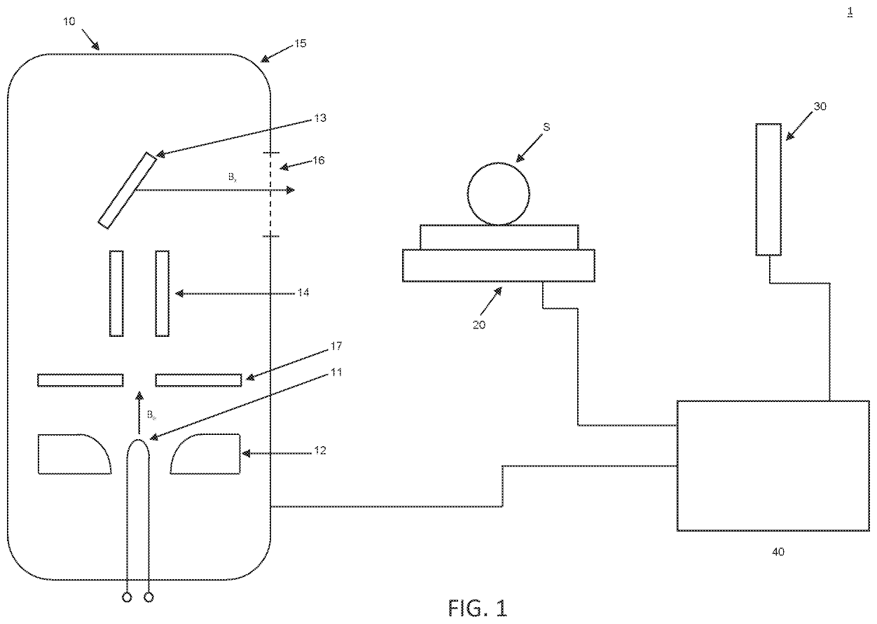

FIG. 1 shows a schematic diagram of an X-ray structure measuring system 1, which may be used for measuring or obtaining images of an object S.

Structure measuring system 1 comprises an X-ray apparatus 10, sometimes referred to as an X-ray source or X-ray gun, which generates a beam B_{X} of X-rays travelling towards object S.

Object S is supported by stage 20 which is positioned so as to support object S in the path of the X-ray beam B_{X}. The X-rays of beam B_{X}, having passed through object S, continue to strike X-ray detector 30, providing information about the structure of object S.

X-ray structure measuring system 1 is controlled by controller 40, which is connected by data/control lines to each of X-ray source 10, stage 20, and detector 30. Thereby, controller 40 can control the operation and parameters of X-ray beam B_{X}, the position and operation of stage 20, and the operation of detector 30, as well as receiving image information from detector 30, and status information from X-ray source 10 and stage 20.

In the example of FIG. 1, the structure measuring system is a computerised tomography system, in which a sequence of images of object S are acquired as object S is rotated on stage 20 in the path of beam B_{X}. Some or all of the sequence of images are subsequently combined using computerised tomography techniques as are known to those skilled in the art to generate three-dimensional structural information, also referred to as volumetric structural information, about the interior structure and external contours of object S.

In the example of FIG. 1, X-ray source 10 and detector 30 remain in a fixed positional relationship with stage 20 in the path of X-ray beam B_{X} travelling from X-ray apparatus 10 to detector 30. Stage 20 is, for example, a rotary stage which allows object S to be rotated about an axis perpendicular to the path, for example defined by the centre line, of X-ray beam B_{X} between X-ray source 10 and detector 30, whilst the object S remains supported. In other configurations, stage 20 may be a stage allowing rotation around a first axis perpendicular to the path of X-ray beam B_{X} and also allowing tilt around a second axis perpendicular to the path of X-ray beam B_{X} and perpendicular to the first axis. Such a stage having both rotation and tilt capability can allow improved positioning of the object, or can allow for images used in the volumetric reconstruction to be obtained from a greater range of directions intersecting with the object. In further configurations, stage 20 may also be equipped with a linear axis to allow object S to be translated in one, two or three degrees of linear motion, thereby to allow for translation of object S in the path of beam B_{X} in order to achieve a desired positioning of object S in the path of beam B_{X}.

The configuration shown in FIG. 1 is also applicable to an X-ray structure measuring system which does not provide volumetric reconstruction, and which may only provide two-dimensional images. In such a configuration, stage 20 may have the same or similar configuration as previously described, in order to allow images to be obtained from a greater range of directions intersecting with the object. In such configurations, alternatively, stage 20 may be absent, or may be replaced by a sample holder having a fixed position or an adjustable position.

In other configurations which operate according to equivalent principles as those described with reference to FIG. 1, object S may remain stationary while X-ray source 10 and detector 30 are arranged to rotate together about one or two axes of rotation in an opposed relationship about object S in one or more axis of rotation. Such rotation can be provided by, for example, arranging source 10 and detector 30 on opposed sections of a rotary support or rotating gantry, with the object S being supported by a stage or sample holder as previously described at the axis of rotation.

In the configuration shown in FIG. 1, X-ray source 10 has a vacuum enclosure 15 which contains within it a filament 11 and a target 13. In operation, filament 11 is heated and is provided with a negative potential to emit electrons by a process of thermionic emission. The electrons thus generated, shown in FIG. 1 as electron beam Be, strike target 13, which comprises an X-ray generating material such as tungsten, rhodium or molybdenum, silver, copper or gold, such that, as a result of electron beam Be striking target 13, a beam B_{X} of X-rays is emitted from target 13. The choice of target material may influence the emitted spectrum of X-rays, and is accordingly selected according to the desired characteristics of the x-ray beam.

To promote the incidence of electron beam Be on target 13, target 13 may be connected to ground, or may be connected to a potential different from ground, such as a positive potential, which is, for example, a more positive potential than the negative potential of filament 11, thereby to attract the electrons travelling from filament 11.

Surrounding filament 11 is grid electrode 12, which has a potential similar to or slightly more negative than filament 11 and which provides a local negative potential around filament 11 for repelling electrons emitted by the filament to form the electron beam Be travelling away from the filament, as well as to regulate the electron beam current from filament 11.

Arranged between filament 11 and target 13 is an anode electrode 17, which may be connected to ground, or may be at an adjustable potential to provide further control of the flux and energy of the electrons of electron beam Be between filament 11 and target 13.

Also arranged between filament 11 and target 13, and on the target side of anode electrode 17, is electrostatic lens 14 as an electron lens, to which a potential may be applied to control the focus of electron beam Be striking target 13. Electrostatic lens 14 has the form of a plurality of cylinders having gaps arranged between and dimensioned to allow electron beam Be to pass through the cylinders. When each cylinder has a different potential, the gaps between the cylinders can operate as a lens to converge or diverge the electron beam. Annular openings can, in a variant configuration, be used as an electrostatic lens, as will be appreciable by those skilled in the art.

All of filament 11, grid electrode 12 and anode electrode 17, target 13 and electrostatic lens 14 are depicted as contained within enclosure 15, which is sealable so as to support a vacuum inside. However, in a variant configuration, electrostatic lens 14 can be replaced by a magnetic lens as an electron lens, such as a focussing coil. To avoid thermal and sealing complexity, such coils may be arranged outside a tubular section of the enclosure 14 made of a non-magnetic material.

Enclosure 15 may be made substantially of any gas-tight material, and may be formed in sections of different materials, such as metal, glass or resin. Gas-tight seals may be provided between the different sections.

Enclosure 15, by virtue of its overall gas-tight construction, may thereby be brought to condition of relative vacuum by pumping on a pump-out port (not shown), which condition of relative vacuum serves to allow a free transmission of the electron beam Be from filament 11 to target 13 without substantial absorption. Forming part of enclosure 15 is window 16, which is formed of a material which is different to the material forming the remainder of enclosure 15, and which is formed of a material which is relatively transmissive to X-rays but relatively opaque to electrons, such as beryllium, aluminium, graphite or diamond. Window 16 thereby allows X-ray beam B_{X} to pass out of enclosure 115 without substantial absorption.

The entire measuring system 1 is typically provided with a surrounding radiodense enclosure, not shown, which serves to prevent leakage of X-rays generated by source 10 to the exterior of the measuring system.

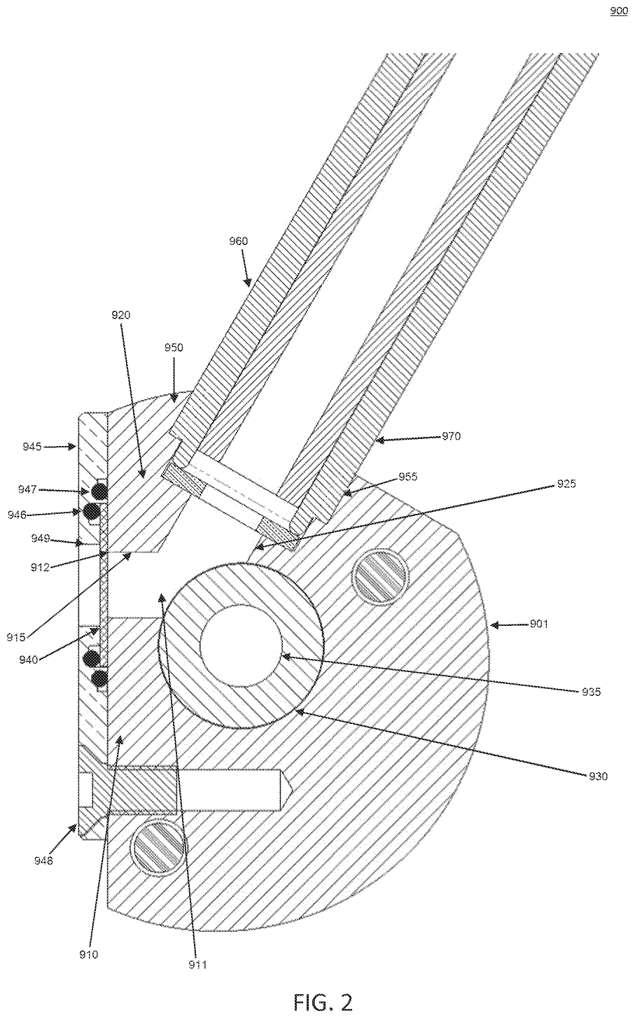

In FIG. 1, the support arrangements for target 13 are not shown. FIG. 2 shows a cross-section through a typical configuration for supporting an X-ray generating target in a target housing, so as to allow an X-ray beam easily to be generated. The configuration of FIG. 2 thus constitutes a target assembly to which an electron beam may be introduced and from which an X-ray beam may be emitted. Such a housing forms the upper part of vacuum enclosure 15 shown in FIG. 1, and is connected to the remainder of vacuum enclosure 15 containing the components which produce and direct the electron beam, namely the electron lens 14, anode electrode 17, filament 11 and grid electrode 12, in a gas-tight manner.

Target assembly 900 shown in FIG. 2 supports a rotary X-ray target 930 on an axle 935, such that target 930 can be rotated around axle 935 by a rotary drive, not shown, or manually. Target 930 can thus be rotated. This may be useful, for example, in the case where the point of the target to which the electron beam is incident has eroded as a result of illumination by the electron beam, so that an undamaged portion of the target can be brought into the path of the beam.

Target 930 is supported in target housing 901, which has an entrance part 920 for accepting an electron beam, an exit part 910 for allowing an X-ray beam generated by the incidence of the electron beam onto target 930 to exit the housing, and a mount part 950 for connecting the target housing 901 to the remainder of the vacuum enclosure 15 which houses the aforementioned components which produce and direct the electron beam.

As can be seen in FIG. 2, an electron beam may be introduced to target housing 910 along electron beam tube 960, which has a connection part 970 configured to engage with socket 955 formed in mount part 950 of target housing 901. The connection is gas-tight by means of appropriate seals interposed between the end of tube 960 and socket 955, so as preserve a vacuum in which the electron beam travels from electron beam tube 960 to an interior of target housing 901.

Entrance part 920 is provided with an entrance path 925 formed as an entrance bore between socket 955 and a position at which target 930 is arranged. An interior of electron beam tube 960 is aligned with entrance path 925 to allow an electron beam to be incident on a desired incidence position on target 930.

Exit part 910 is provided adjacent to target member 930 and includes an exit path 915 formed by an exit bore. The exit path 915 extends between a surface of target housing 901 from which X-rays are to be emitted and target member 930.

Covering an exit aperture 912 of exit bore defining the exit path 915 is X-ray transmissive window 940, which is formed of an X-ray transmissive material, such as beryllium. Window 940 is secured over exit aperture 912 of exit bore 915 by mounting plate 945. Mounting plate 945 is mounted against a flat surface of target housing 901 having the exit aperture 912 formed therein, so as to locate transmission window 940 securely over exit aperture 912.

Mounting plate 945 has a recess arranged to face the surface of the target housing 901 to accommodate transmission window 940 so that the surface of transmission window 940 is substantially flush with the surrounding surface of mounting plate 945. An opening 949 is formed in mounting plate 945 extending from the recess to an opposite surface of mounting plate 945 in the form of a through-hole which is arranged to be aligned with and to be positioned over exit aperture 912, with X-ray transmissive window 940 between opening 949 and exit aperture 912, to allow generated X-rays to pass from exit bore 915 through transmissive window 940 and further through opening 949. The generated x-rays can thus be directed towards an object under investigation.

A first seal 946 in the form of an O-ring is provided between X-ray transmissive window 940 and mounting plate 945 while a second seal 947 is provided, also in the form of an O-ring, between mounting plate 945 and the surface of the target housing 901. Mounting plate 945 is secured to target housing 901 by an appropriate fixture, exemplified in FIG. 2 by mounting screw 948, of which one or more may be provided as needed to secure mounting plate 945 in a gas-tight manner to the remainder of target housing 901.

In the configuration of target assembly shown in FIG. 2, therefore, an electron beam arrives through electron beam tube 960 and, passes through entrance path 925 defined by the entrance bore so as to strike target member 930. X-rays thereby generated are emitted from target member 930 along exit path 915 through X-ray transmissive window 940 to be directed towards an object under investigation. The configuration in FIG. 2 thus operates in so-called reflection mode, wherein the path of the X-ray emission is along a different direction to the direction of the incident electron beam to the target. This is in contrast to so-called transmission mode arrangements, in which the x-ray emission is along substantially the same direction as the direction of the incident electron beam.

In the configuration of FIG. 2, at least the body of target housing 901 is typically formed from tungsten-copper, for example an 80% tungsten/20% copper alloy or another tungsten copper alloy containing a high proportion of tungsten, which exhibits low thermal expansion. Other parts such as electron beam tube 960, connection part 970, and mounting plate 945 may also be formed from such tungsten-copper, or from another suitable material.

When the target assembly of FIG. 2 is operated, it is observed that an undesirable secondary image of the object to be observed is sometimes obtained in the acquired image data.

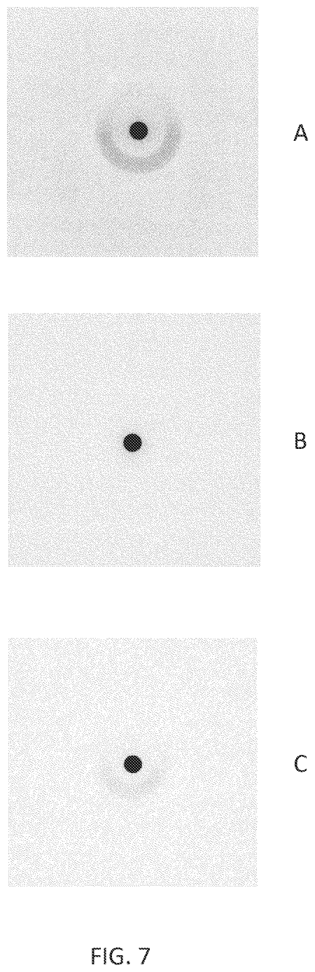

For example, when a 1 mm diameter tungsten-copper ball is imaged with a beam energy of 120 kV and 6 W using such a conventional target, the image shown in FIG. 7a is acquired. In FIG. 7a, surrounding the image of the 1 mm diameter tungsten-copper ball, a circular second image can be observed, which can be understood as a super position of faint (ghost) images of the tungsten-copper ball, arranged on a circular locus or path around the centre of the emitted X-ray beam. Depending on the intensity of the effect, it may be necessary to stretch the contrast of the image to allow the effect shown in FIG. 7a to be clearly visible to the eye. The presence of such secondary images, whether visible or not, reduces the image contrast and fidelity, and can interfere with appropriate volumetric reconstruction by standard computerised tomography techniques.

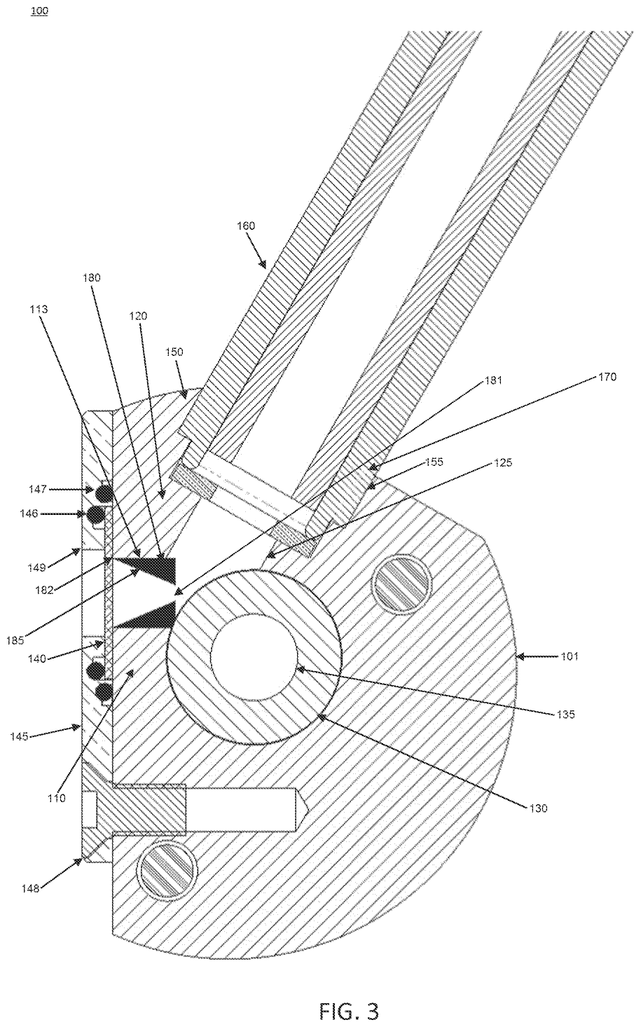

Accordingly, according to the present invention, the target assembly 900 shown in FIG. 2 is modified to arrive at a first embodiment of the invention as shown in FIG. 3.

Target assembly 100, being a first embodiment of the present invention and shown in FIG. 3, corresponds substantially in structure and function to target assembly 900 shown in FIG. 2, except as described below. Accordingly, the parts of target assembly 100 which are assigned reference signs 1XX should be taken to correspond directly with in structure and function with like parts 9XX shown in FIG. 2.

Target assembly 100 shown in FIG. 3 is provided with insert 180. Insert 180 is constructed in the form of a plug, and is made of a similar or identical material to target housing 901. For example, insert 180 may be made of tungsten-copper. Insert 180 is dimensioned in length and outer diameter to fit within exit bore of target housing 101, and has a tapered internal bore between an entrance aperture 181 at a position closest to target member 130 and an exit aperture 182 of insert 180 at a position furthest from target member 130. In the embodiment of FIG. 3, the tapered exit bore 185 is in the form of a cone, with an internal surface which tapers in a straight line, but could also be formed with a curved or stepped internal taper, without limitation.

The degree of taper of the internal bore 185 of insert 180 is selected to match the desired cone angle of the X-rays emitted from target member 130, which is typically determined by the geometry of the remainder of the X-ray structure measuring apparatus in which the target assembly 100 is to be incorporated. For example, the cone angle may be selected so as to completely fill an x-ray sensitive surface of the detector at the intended distance of the detector from the target.

In the configuration of FIG. 3, insert 180 extends from a position immediately adjacent transmission window 140 to a position immediately adjacent to target member 130, but inset 180 may be provided with a shortened axial direction, if desired.

In the absence of insert 180, electrons which strike target member 130 and which are subsequently scattered from the target of member 130 may strike an interior surface of target housing 901 and may generate unwanted electrons which are then emitted through transmission window 140. Such is hypothesised to be the origin of the secondary image shown in FIG. 7a when the target assembly 900 of FIG. 2 is operated.

By providing insert 180 to target assembly 100, a non-cylindrical exit bore is provided, which thus limits the possibility for electrons, which have been scattered or reflected from the target member, to strike an interior of the bore, and there by to generate a secondary source of X-rays.

Accordingly, by the configuration shown in FIG. 3, the incidence of undesirable secondary images is reduced.

This can be observed with reference to, for example, FIG. 7b, which shows the effect of introducing a tapered insert 180 as shown and described in connection with FIG. 3 to an X-ray target assembly as used to generate FIG. 7a. By introducing insert 180, the incidence of an undesired secondary image is almost completely removed, even when the contrast is stretched. Accordingly, the image contrast and fidelity may be improved, and volumetric reconstruction by standard computerised tomography techniques may be more successful.

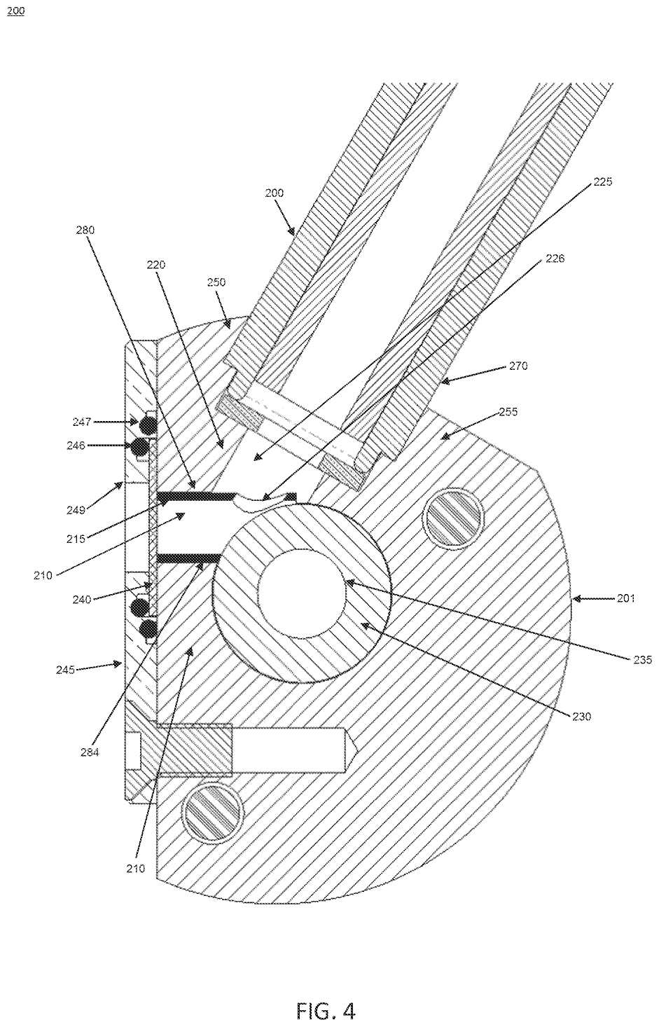

A second embodiment of the present invention will be described with reference to FIG. 4. Again, parts similar in structure and function to those of target assembly 900 shown in FIG. 2 are denoted with reference numeral 2XX and correspond to like parts 9XX shown in FIG. 3.

The target assembly 200 of FIG. 4 is provided, at an interior of exit bore 215, with liner 280. Liner 280 is formed of a material having a lower atomic number than the atomic number of the predominant material of body of target housing 101. Since target housing 101 is, in the present embodiment, made of tungsten-copper, liner 280 may, for example, be formed of material having an atomic number less than 16, and may preferably be formed of aluminium, beryllium or carbon.

In the present embodiment, liner 280 has a cylindrical outer surface and cylindrical inner surface, and has a wall thickness which is greater than the penetration depth of electrons with which the target is designed to operate. In particular, in the embodiment of FIG. 4, liner may have a 4 mm outside diameter and a 3 mm inside diameter. Liner 280 may therefore have a wall thickness of 1 mm. In other configurations, the wall thickness may be greater than 10 micron, greater than 15 micron, greater than 25 micron, greater than 50 micron, or greater than 100 micron. Further, for ease of manufacture, the liner may have a wall thickness which is less than 2 mm, optionally less than 1 mm, optionally less than 500 micron or optionally less than 250 micron. The liner extends between a position adjacent transmission window 240 and a position adjacent target member 230, and substantially lines the exit bore 215 of target housing 201.

The liner 280 also has a projection portion 185 projecting from a cylindrical insertion part 184 which is shaped and dimensioned to lie within exit bore 215 so as to project across the electron beam entrance path 225. Projection portion 285 has a circular aperture 286 formed therein which is dimensioned to allow passage of the electron beam through projection portion 285. Other shapes than circular can be contemplated for the aperture 286 formed in projection portion 285.

Liner 280 functions to absorb scattered electrons, thereby preventing them from reaching the surface of exit bore 215 of target housing 201 with an energy sufficient to generate X-rays. By adjusting the thickness of liner 280, the degree of reduction of unwanted X-rays can be controlled.

As shown in FIG. 4, the projection portion 285 extending from insertion part 284 of liner 280 is shaped to conform to a surface of target member 230, so that a small clearance can be allowed between target member 230 and projection portion 285. In the embodiment of FIG. 4, projection portion 285 is formed so as to have a substantially cylindrical transverse cut-out from an overall cylindrical axial form of liner 280.

Other shapes may be contemplated for liner 280 than cylindrical, although it is preferred that such shapes have, at least for the insertion part 284, a shape of high symmetry around a longitudinal axis of liner 280, for example a regular polygonal prism. The shape of the exterior surface of liner 280 in cross-section is preferably matched to the cross-sectional shape of exit bore 215, while the interior cross-sectional shape may be the same or different. In the embodiment of FIG. 4, the insertion part 284 has cylindrical symmetry about its longitudinal axis.

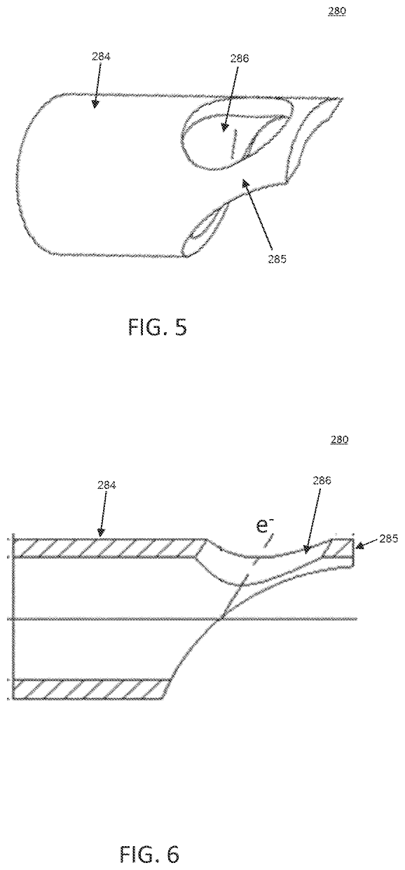

FIGS. 5 and 6 show alternative views of liner 280, FIG. 5 showing an external view of liner 280 in isolation, that is, removed from exit bore 215, while FIG. 6 shows liner 280 in cross-section, showing the substantially cylindrical insertion portion 284 and the projecting portion 285 having aperture 286 being cut away to accommodate target member 230.

Application of a liner as shown in FIG. 4 to the configuration of FIG. 2 under the same imaging conditions as described above in connection with FIG. 7a results in an image of the tungsten-copper ball as shown in FIG. 7c. Again, a noticeable reduction in the circular secondary image of the tungsten ball can be observed. Similar to the first embodiment, by introducing insert 280, the incidence of an undesired secondary image is to a large extent removed, even when the contrast is stretched. Accordingly, the image contrast and fidelity may be improved, and volumetric reconstruction by standard computerised tomography techniques may be more successful.

Further, the liner of FIG. 4 can be provided, with appropriate adaption, to the interior of the insert 180 shown in FIG. 3. In such a configuration, a tapered liner of thickness and material as described in connection with FIG. 4 is provided within the tapered exit bore 185 of insert 180 thereby to absorb any electrons which, even taking account of the tapered bore of insert 180, arrive at the surface of the tapered bore. Providing such a liner can absorb even these electrons, and can further reduce the incidence of unwanted secondary images.

Although in the above it has been described that insert 180 and liner 280 have been provided as discrete components of target assembly which may be integrated with target assemblies at the time of manufacture. However, it is also possible to retrofit such inserts or liners to existing target assemblies, thereby to improve their imaging performance.

Moreover, although in the above, it has been described that insert 180 and liner 280 are discrete components to be applied to the target assembly, in an alternative configuration, the element 180 shown in FIG. 3 can be provided as an integral part of the target housing, rather than as an insert thereto. Such can be produced by, for example, appropriate forming of the exit bore of the target housing to have an appropriately tapered shape which increases in cross-section in a direction from an X-ray entrance side of the bore. Similarly, a liner as shown described in connection with FIG. 4 can be provided at the time of manufacturing by an appropriate coating of a lining material on an inner surface of an exit bore of a target assembly, rather than as a separate part to be applied. Such a coating can be provided, for example, by coating techniques as known in the art.

Accordingly, the above embodiments should be understood to be exemplary, while the scope of the invention claimed should be defined solely by the appended claims.

1. A target assembly for an x-ray apparatus, the target assembly comprising:
a target housing;
an entrance path formed in an entrance part of the target housing for accepting an incident electron beam;
a target member for generating x-rays under electron beam illumination through the entrance path; and
an exit path formed in an exit part of the target housing for allowing generated x-rays to exit the target assembly, the exit path covered by an x-ray transmissive window,
wherein the exit path comprises an exit bore formed in the exit part and configured to limit the generation of x-rays by impact of scattered electrons, which have been reflected from the target member, onto an inside of the bore.

2. The target assembly of claim 1, wherein the exit bore is non-cylindrical.

3. The target assembly of claim 1, wherein the exit bore increases in cross-section in a direction from an x-ray entrance side of the bore.

4. The target assembly of claim 1, wherein the exit bore is conical.

5. The target assembly of claim 1, wherein the exit bore has a cone angle matching a cone angle defined between an x-ray incidence point on the target and an exit aperture of the exit bore.

6. The target assembly of claim 1, wherein the exit part has a plug providing the exit bore.

7. The target assembly of claim 1, wherein the exit bore is provided with a liner predominantly composed of a material having lower atomic number than the atomic number of the predominant material of a surface of the exit part inward of the liner, the atomic number being lower than 16, the liner extending substantially around a cross-section of the bore.

8. The target assembly of claim 1, wherein the exit bore is provided with a liner of aluminium, beryllium or carbon.

9. The target assembly of claim 7, wherein the liner has a wall thickness which is greater than the penetration depth of electrons with which the target is designed to operate.

10. The target assembly of claim 7, wherein the liner has a wall thickness which is greater than 10 micron.

11. The target assembly of claim 7, wherein the liner has a wall thickness which is less than 2 mm.

12. The target assembly of claim 7, wherein the liner has a projection portion which extends inward of the exit bore and which is interposed between the entrance bore and the target member, the projection portion having an aperture for admitting the electron beam to the target.

13. The target assembly of claim 12, wherein the projection portion is formed to conform to a surface of the target member, to be spaced apart from a surface of the target member by less than 2 mm.

14. The target assembly of claim 1, wherein the entrance path is along an entrance bore of the entrance part.

15. The target assembly of claim 14, wherein the entrance path is along a centreline of the entrance bore.

16. The target assembly of claim 14, wherein the entrance bore has a circular cross-section.

17. The target assembly of claim 12, wherein the aperture of the projection portion has a circular cross-section.

18. The target assembly of claim 1, wherein the target member has a rod-shaped target portion arranged to be in the path of the incident electron beam.

19. The target assembly of claim 1, wherein the target housing is radiopaque.

20. The target assembly of claim 1, wherein the target assembly is made of tungsten-copper.

21. The target assembly of claim 1, wherein the window is made of beryllium, aluminium, graphite or diamond.

22. An x-ray apparatus comprising the target assembly of claim 1 and an electron beam generator arranged to generate an electron beam incident on the target member.

23. The x-ray apparatus of claim 22, further comprising an electron lens configured to focus the electron beam to a focal spot on the target member.

24. A structure measurement apparatus comprising the x-ray apparatus according to claim 23 and an x-ray detector arranged for measuring the structure of an object interposed between the x-ray apparatus and the x-ray detector.

25. A structure measurement method comprising using the x-ray apparatus according to claim 23 and an x-ray detector to measure the structure of an object interposed between the x-ray apparatus and the x-ray detector.

26. A method of modifying a target assembly for an x-ray apparatus, the target assembly comprising:
a target housing;
an entrance path formed in an entrance part of the target housing for accepting an incident electron beam
a target member for generating x-rays under electron beam illumination through the entrance path; and
an exit path formed in an exit part of the target housing for allowing generated x-rays to exit the target assembly, the exit path covered by an x-ray transmissive window,
wherein the exit path comprises an exit bore formed in the exit part, and
wherein the modification comprises limiting the generation of x-rays by incidence of scattered electrons, which have been reflected from the target member, onto an inside of the bore.

27. The method of claim 26, wherein the modification comprises modifying the exit bore to be non-cylindrical.

28. The method of claim 26, wherein the modification comprises modifying the exit bore to increase in cross-section in a direction from an x-ray entrance side of the bore.

29. The method of claim 26, wherein the modification comprises modifying the exit bore to be conical.

30. The method of claim 26, wherein the modification comprises modifying the exit bore to have a cone angle matching a cone angle defined between an x-ray incidence point on the target and an exit aperture of the exit bore.

31. The method of claim 26, wherein the modification comprises providing a plug to the exit bore.

32. The method of claim 26, wherein the modification comprises providing the exit bore with a liner predominantly composed of, a material having lower atomic number than the atomic number of the predominant material of a surface of the exit part inward of the liner, the atomic number being optionally lower than 16, the liner extending substantially around a cross-section of the bore.

33. The method of claim 26, wherein the modification comprises providing the exit bore with a liner of aluminium, beryllium or carbon.

34. The method of claim 32, wherein the liner has a wall thickness which is greater than the penetration depth of electrons with which the target is designed to operate.

35. The method of claim 32, wherein the liner has a wall thickness which is greater than 10 micron, optionally greater than 15 micron, optionally greater than 25 micron, optionally greater than 50 micron, optionally greater than 100 micron.

36. The method of claim 32, wherein the liner has a wall thickness which is less than 2 mm, optionally less than 1 mm.

37. The method of claim 32, wherein the liner has a projection portion which extends inward of the exit bore and which is interposed between the entrance bore and the target member, the projection portion having an aperture for admitting the electron beam to the target.

38. The method of claim 37, wherein the projection portion is formed to conform to a surface of the target member, to be spaced apart from a surface of the target member by less than 2 mm.

39. The method of claim 26, wherein the entrance path is along an entrance bore of the entrance part.

40. The method of claim 39, wherein the entrance path is along a centreline of the entrance bore.

41. The method of claim 40, wherein the entrance bore has a circular cross-section.

42. The method of claim 37, wherein the aperture of the projection portion has a circular cross-section.

43. The method of claim 26, wherein the target member has a rod-shaped target portion arranged to be in the path of the incident electron beam.

44. The method of claim 26, wherein the target housing is radiopaque.

45. The method of claim 26, wherein the target assembly is made of tungsten-copper.

46. The target assembly of claim 26, wherein the window is made of beryllium, aluminium, graphite or diamond.

47. The method of claim 26, further comprising applying an incident electron beam to the target member and observing reduced x-ray generation from the incidence of electrons, which have been reflected from the target member, onto an inside of the bore.

48. The method of claim 26, further comprising applying an incident electron beam to the target member and observing a reduced intensity of ghost images of a test object, the ghost images arranged on a circular locus surrounding a true image of the test object on an imaging plane, the test object being arranged between the target member and the imaging plane.

49. The method of claim 48, further comprising adjusting the configuration of the exit bore to observe the reduced intensity of ghost images of the test object.

50. A method of modifying an x-ray apparatus comprising a target assembly of claim and an electron beam generator arranged to generate an electron beam incident on the target member, the method comprising modifying the target assembly in accordance with the method of claim 26.

51. The method of modifying the x-ray apparatus of claim 50, wherein the x-ray apparatus further comprises an electron lens configured to focus the electron beam to a focal spot on the target member.
